(19) United States
(12) Patent Application Publication
(10) Pub. No.: US 2008/0217128 A1
(43) Pub. Date: Sep. 11, 2008

(54) Energy Absorption Apparatus and Method for Producing an Integral Energy Absorption Apparatus

(76) Inventors: Toros Akgun, Graz (AT); Michael Blumel, Flatz (AT)

Correspondence Address: MAGNA INTERNATIONAL, INC., 337 MAGNA DRIVE, AURORA, ON, L4G-7K1, CA

(21) Appl. No.: 11/917,096

(22) PCT Filed: Apr. 13, 2006
(86) PCT No.: PCT/EP2006/003434

§ 371 Date: Jan. 21, 2008

(30) Foreign Application Priority Data
Jun. 8, 2005 (DE) 10 2005 026 441.1

(51) Int. Cl. F16F 7/12

(52) U.S. Cl. 188/377

(57) ABSTRACT

The present invention relates to an energy absorption apparatus having a first hollow longitudinal section (2) with a first cross-sectional width (5) and a second hollow longitudinal section (3) with a second cross-sectional width (6) and having an overlapping transition region (4) between the hollow longitudinal sections. The invention also relates to a method for producing an integral energy absorption apparatus. In order to provide an energy absorption apparatus having an easily determinable deformation response, the second hollow longitudinal section is designed to have a higher strength than the first hollow longitudinal section. In the method according to the invention for producing an energy absorption apparatus, a tube with a first cross-sectional width is narrowed, in sections, to the second cross sectional width so as to form the hollow longitudinal sections and the tube is compressed, as a result of which the overlapping transition region is formed.

The present invention relates to an energy absaborption apparatus with the features of the preamble of claim 1 as well as a method for producing an integral energy absorption apparatus.

From DE 93 11 163 U1 generic energy absorbing devices called damping elements are known. Damping elements of this type are disposed in vehicles between bumpers and the body in order to deform plastically in case of an accident before plastic deformation of the body occurs. In this way a significant part of kinetic energy is dissipated over a short displacement. In the case of minor accidents the energy absorbing capacity of the damping elements can be sufficient to avoid plastic deformation of the body, which clearly reduces the repair costs for the vehicle.

In designing and constructing the body, the deformation processes and the energy absorbing capacity of the energy absorbing device must be taken into account. If the energy absorbing capacity is overestimated, the body turns out to be too hard.

If the energy absorbing capacity is underestimated, the body turns out to be too soft. In addition, stronger deformations of the body than required are allowed. In a corresponding manner the passenger area can be deformed more easily and the repair costs clearly turn out to be higher.

The present invention is based on the objective of providing an energy absorbing device with deformation behavior, which can be well specified as well as a process for producing such an energy absorbing device.

The objective is realized according to the invention with an energy absorbing device having the features of claim 1.

By providing the second hollow longitudinal segment with greater strength a deformation of the energy absorbing device is at the expense of the first hollow longitudinal segment while the second hollow longitudinal segment essentially retains its form. That is, the deformation behavior of the energy absorbing device can be well specified in advance, whereby its energy absorbing capacity can also be well specified in advance.

Advantageously, the second hollow longitudinal segment can have received its greater strength by forming. In this way the forming of the second hollow longitudinal segment and the providing of its greater strength can be combined into one production step.

Advantageously, the second hollow longitudinal segment can have a greater wall thickness than the first hollow longitudinal segment. This increases the strength of the wall of the second hollow longitudinal segment with respect to the wall of the first hollow longitudinal segment.

Particularly preferably, the transitional area can have greater strength than the first hollow longitudinal segment. This stabilizes the transitional region and supports a good initiation of an everting deformation of the first hollow longitudinal segment.

Preferably, the energy absorbing device can comprise a strengthening profiling in its wall. The energy absorbing device is strengthened against deformation in that area in which the profiling is provided. In particular, the geometrical moment of inertia of the profiling acts in a strengthening manner.

Advantageously, the profiling can be formed in such a manner that it extends essentially in the longitudinal direction of the energy absorbing device. With this, the energy absorbing device is strengthened against a deformation in the direction transverse to its longitudinal direction.

Preferably, the profiling can be provided in such a manner that it extends approximately over the entire area of the second hollow longitudinal segment. Thereby the second hollow longitudinal segment is strengthened.

Advantageously, the profiling can be provided in such a manner that it is adjacent to the second hollow longitudinal segment in the overlapping transitional region. Thereby the transitional area adjacent to the second hollow longitudinal segment is strengthened, which acts against an everting deformation of the second hollow longitudinal segment and supports an initiation of the everting deformation of the first hollow longitudinal segment.

Particularly preferably, the transitional area can have at least one inner radius in the range of approximately 1 mm to approximately 4 mm, preferably in the range of approximately 1.5 mm. In these dimensions the first and second hollow longitudinal segments can be disposed relatively near to one another for good control, where the everting deformation can run well and be energy-intensive.

Advantageously, the transitional area can comprise, formed on sides of the second hollow longitudinal segment, folds whose walls are connected to one another by joining. This stabilizes the transitional area and supports a good initiation of the everting deformation of the first hollow longitudinal segment.

Particularly favorably, the walls can be welded, soldered, or glued to one another. This type of joining can be produced simply and rapidly, where the gluing can be realized with particularly little effort but good action nonetheless.

Preferably, the energy absorbing device can have wall thicknesses in the range of approximately 1 mm to approximately 4 mm, preferably in the range of approximately 1.5 to approximately 2.5 mm. With these wail thicknesses energy absorption values can be realized with which in the case of minor impact accidents, e.g., in the range of 10 km/h, sufficient energy can be dissipated over a short displacement to essentially avoid a plastic deformation of the body.

Particularly advantageously, the energy absorbing device can be formed in an integral manner. Thereby, the geometry and material properties can change smoothly, which has a favorable effect on the deformation behavior of the energy absorbing device.

The objective is furthermore realized according to the invention with a process for producing an integral energy absorbing device, where that process has the features of claim 14.

By the narrowing of the tube to the second cross-sectional width a strengthening of the second hollow longitudinal segment is associated with the forming of the same. The advantages of an energy absorbing device with the strengthened second hollow longitudinal segment have already been explained.

With the narrowing and compressing, an integral energy absorbing device can be produced rapidly and with relatively simple means from a tube.

Particularly preferably, the compression can take place during the narrowing. This permits the transitional area and the second hollow longitudinal segment to be formed simultaneously.

Preferably, a material elongation associated with the narrowing can be guided, at least in part, in the direction towards the first hollow longitudinal segment, whereby the transitional region between the hollow longitudinal segments will overlap. In this way the overlapping transitional region and the second hollow longitudinal segment are formed simultaneously, where the process of compression is integrated into the process of narrowing.

Advantageously, end areas of the tube can be held fixed in the longitudinal direction of the tube during the narrowing, wherewith there is a material elongation associated with the narrowing and a double bending of the transitional area between the hollow longitudinal segments. By holding the end areas of the tube fixed, the integrated compression can be realized with simple means, where the compression occurs to the extent that the end is held fixed.

Advantageously, the compression can occur after the narrowing. Formed by the narrowing, the transitional area between the hollow longitudinal segments is deformed by the subsequent compression and strengthened in addition thereby.

Preferably, the wall thickness of the second hollow longitudinal segment can be increased during the narrowing. This strengthens the second hollow longitudinal segment with respect to the first hollow longitudinal segment, where the second hollow longitudinal segment and the increased wall thickness can be produced in a time-saving manner.

Advantageously, the narrowing can be done by rolling. With the rolling, good strengthening is achieved and slightly different cross sections and longitudinal profiles can be formed.

Advantageously, the narrowing can be done by moving the tube through a die which narrows the cross sectional width. With this, a particularly good strengthening of the formed material is achieved.

Particularly advantageously, a stepped, preferably conical, transitional area between the longitudinal sections can be formed with the narrowing. A stepped and, particularly preferably, conical transitional area can be well produced by rolling and using a die and can overlap well by compression. In particular, the conical transitional area is strengthened particularly well in addition by double bending.

Preferably, the wall of the energy absorbing device can be profiled in a strengthening manner during the narrowing. This strengthens the energy absorbing device in the area in which it is profiled against deformation. In particular, the energy absorbing device is strengthened by a strengthening change of the geometrical moment of inertia. In addition, this makes it possible to form the second hollow longitudinal segment and the profiling in a time-saving manner.

Particularly preferably, the narrowing and the profiling can be done with the same die. In this way the narrowing and the profiling are one integrated process.

Embodiments of the present invention are represented in the drawings and are explained in the following. Shown are:

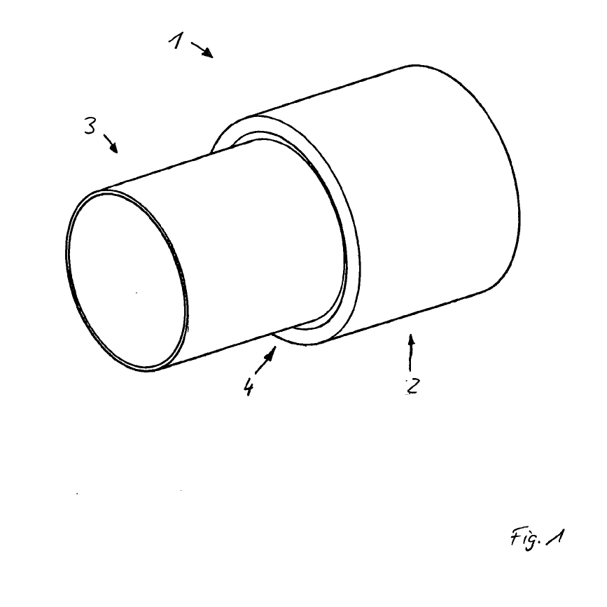

FIG. 1 a perspective view of an energy absorbing device according to the invention,

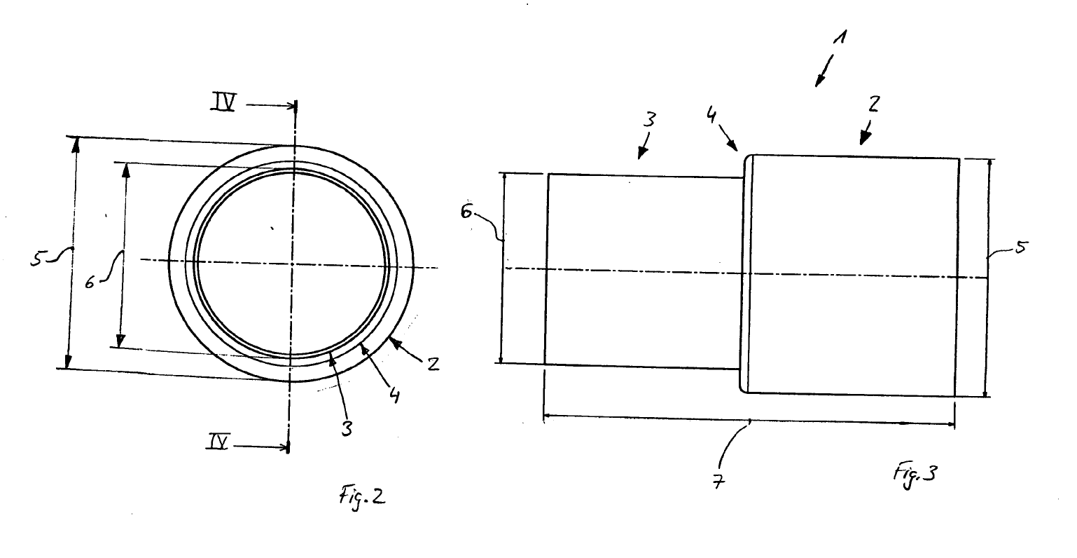

FIG. 2 a front view of the energy absorbing device,

FIG. 3 a side view of the energy absorbing device,

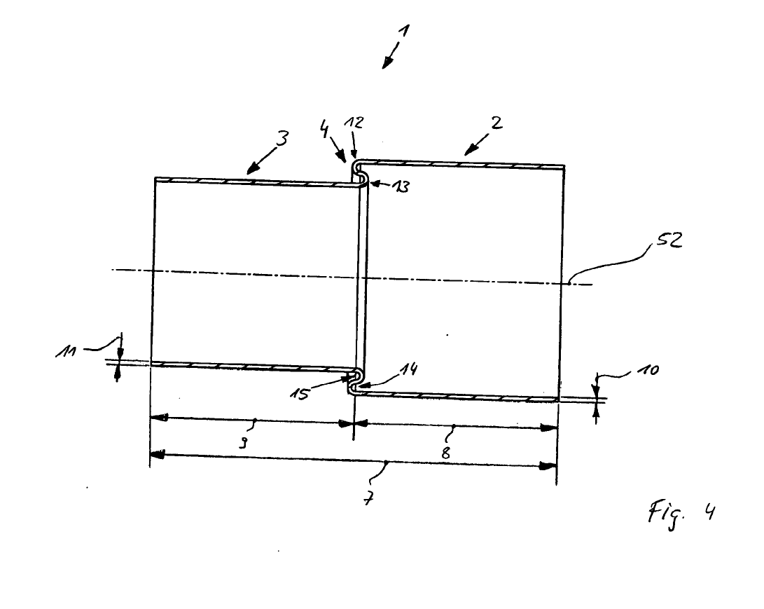

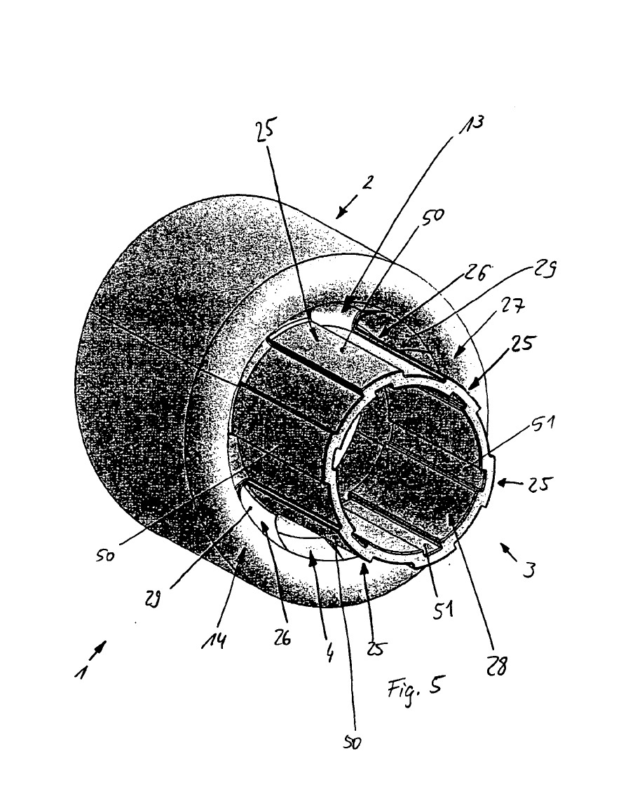

FIG. 4 a longitudinal sectional view of the energy absorbing device, where that view corresponds to line IV-IV in FIG. 2,

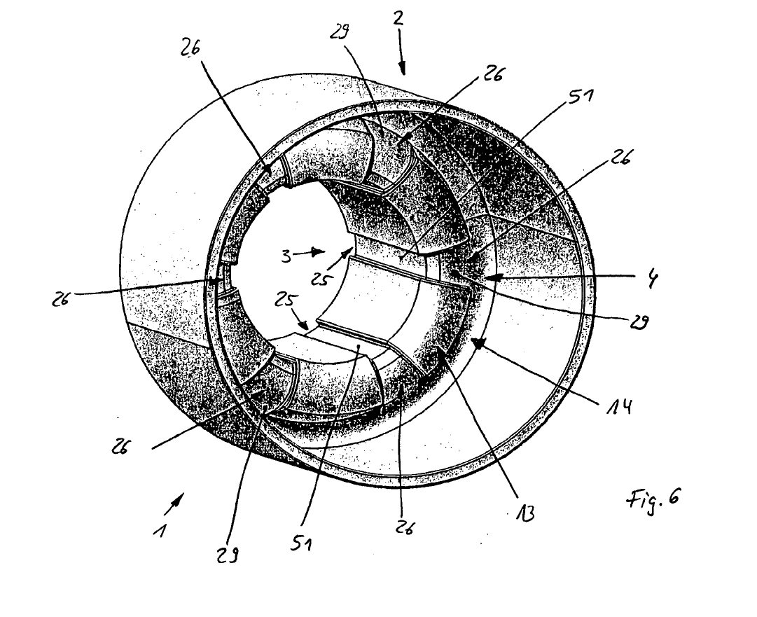

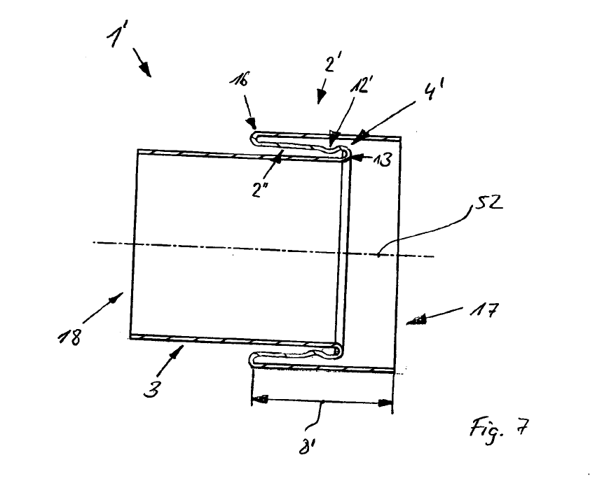

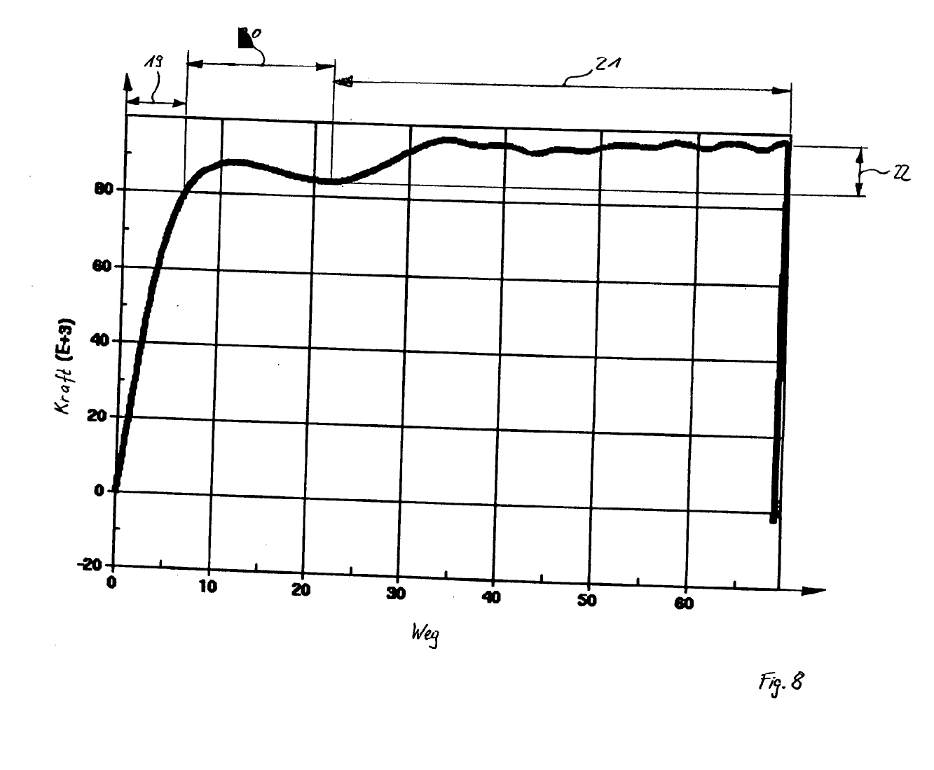

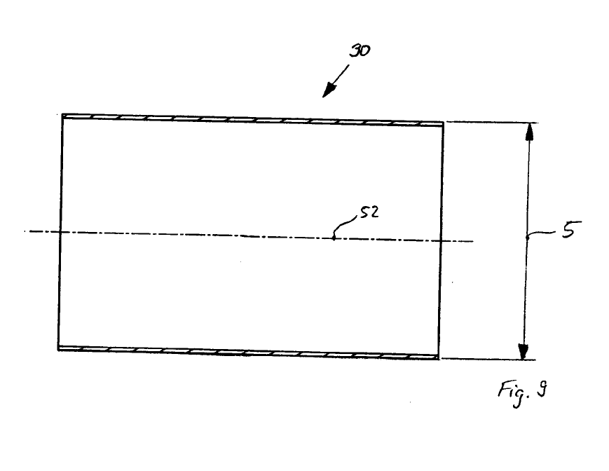

FIGS. 5 and 6 perspective views of the energy absorbing device according to an extension of the present invention and provided with profilings,

FIG. 7 a longitudinal sectional view of the energy absorbing device according to FIG. 4 in the deformed state,

FIG. 8 a force-displacement diagram of the deformation process of the energy absorbing device,

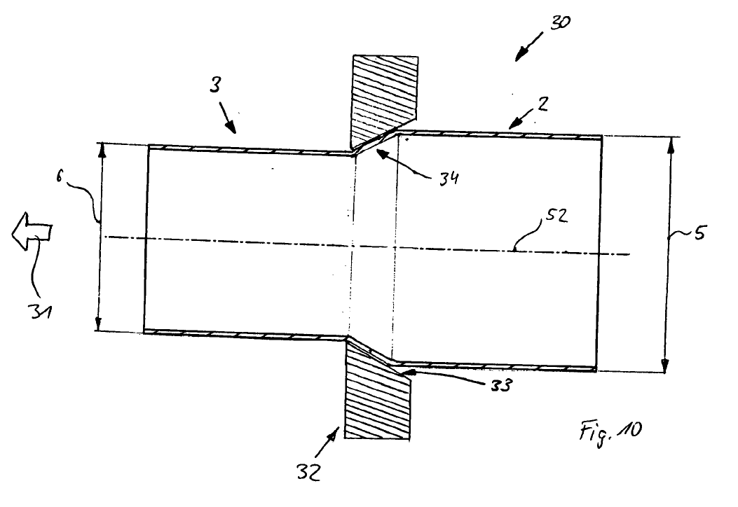

FIG. 9 a longitudinal sectional view of a tube which serves as starting material for the production of an energy absorbing device according to the invention,

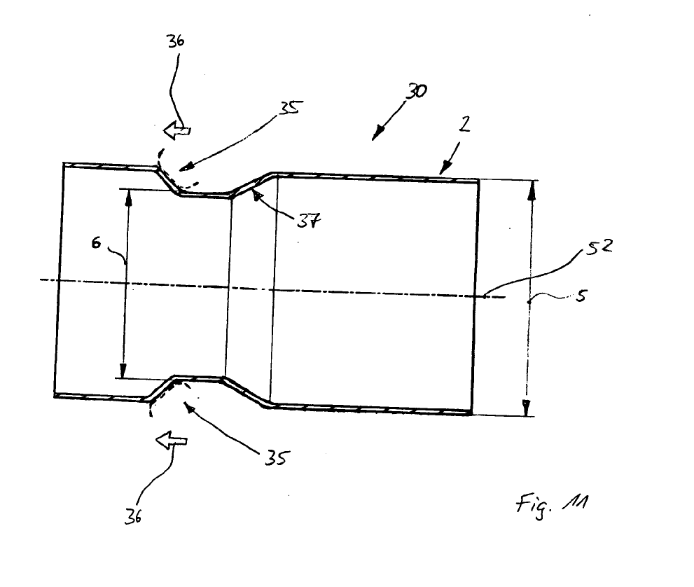

FIG. 10 an illustration of a first embodiment of a production process for an integral energy absorbing device according to the invention,

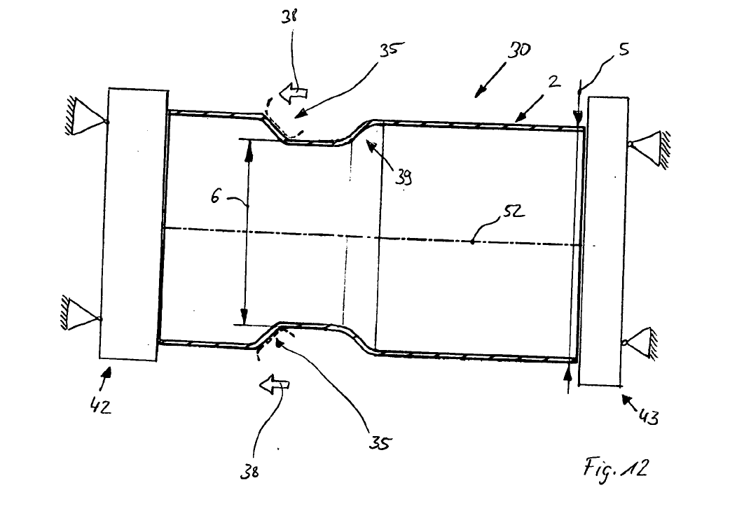

FIG. 11 an illustration of a second embodiment of a production process according to the invention,

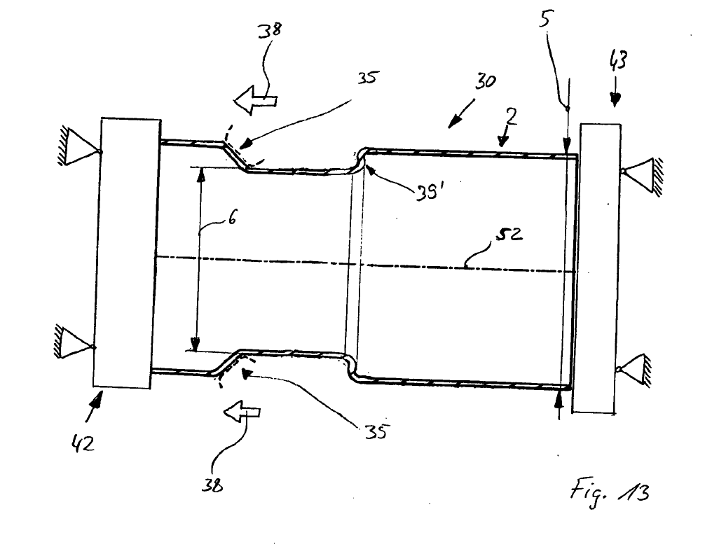

FIGS. 12 and 13 an illustration of a third embodiment of a production process according to the invention in various steps of that process, and

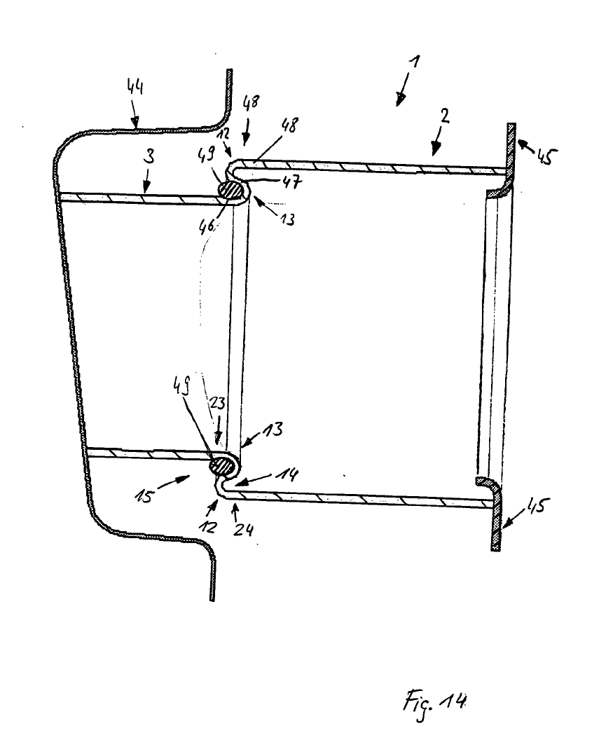

FIG. 14 a longitudinal sectional view of the energy absorbing device according to the invention and having a stabilized transitional area.

FIG. 1 is a perspective view of an energy absorbing device 1 according to the invention which, for example, can be disposed between a bumper and the body of a vehicle and is deformed on impact for absorbing energy before the body is significantly deformed plastically. In less serious accidents, e.g., impact accidents at a speed of approximately 10 to 14 km/h, the energy absorption capacity of the energy absorbing device can be sufficient to protect the body against significant plastic deformations.

The energy absorbing device 1 is formed to be essentially cylindrical. In this connection “cylindrical” means that all the conceivable cross-sectional profiles are possible, cross-sectional transitions and/or tierings are possible, and the peripheral surface can be formed to be closed, interrupted, and/or open. Round forms, for example, can be used as cross-sectional forms.

In this embodiment of the invention, the energy absorbing device has circular cross-sectional profiles and comprises a first hollow longitudinal segment 2 with a first cross-sectional width 5 as well as a second hollow longitudinal segment with a second cross-sectional width 6. The first cross-sectional width 5 is greater than the second cross-sectional width 6, as follows from FIGS. 2 and 3. As the second cross-sectional width 6, values in the range from approximately 60 mm to approximately 80 mm are preferred, in particular values in the range of approximately 70 mm. The first cross-sectional width 5 preferably has values in the range from approximately 80 mm to approximately 100 mm, in particular values in the range of approximately 90 mm.

Indicated in FIG. 3, the total length 7 of the energy absorbing device 1 can preferably have values in the range of approximately 75 mm to approximately 300 mm, in particular values in the range of approximately 100 mm to approximately 250 mm. In the present embodiment, the total length is approximately 150 mm. As follows from the longitudinal sectional view in FIG. 4, the total length 7 is divided approximately in half between the lengths 8 and 9 of the longitudinal segments 2 and 3. From FIG. 4 it furthermore follows that the energy absorbing device in this embodiment of the invention is formed in an integral manner.

The energy absorbing device consists preferably of high-strength steel, e.g., DP 600, and can have wall thicknesses 10 and 11 in the range of 1 mm to 4 mm, in particular in the range of 1.5 mm to 2.5 mm. The wall thicknesses 10 and 11 can vary over the length of the energy absorbing device. In this embodiment of the invention the wall thicknesses 10 and 11 of the longitudinal segments 2 and 3 are approximately equal, namely approximately 1.5 mm.

The overlapping transitional region 4 is formed to be approximately S-shaped in its longitudinal profile. Its S-curve parts 12 and 13 have inner radii 14 and 15 in the range of approximately 1 mm to approximately 4 mm, preferably approximately in the range of 1.5 mm.

The second longitudinal segment 3 and the overlapping transitional region 4 each have greater strength than the first longitudinal segment 2. They can each have obtained their greater strength by recasting but also by other processes, such as, for example, heat treatment. Conversely, the first longitudinal segment 2 can have obtained its lesser strength by a heat treatment.

It is also possible to form the second hollow longitudinal segment to have a greater wall thickness then the first hollow longitudinal segment has. This increases the stability of the second hollow longitudinal segment with respect to deformation, that is, due to this the second hollow longitudinal segment is stronger. This facilitates an everting deformation of the energy absorbing device at the expense of the first hollow longitudinal segment 2.

The greater wall thickness of the second hollow longitudinal segment can be provided in addition to its strengthening by forming and/or heat treatment.

In the case of an extension of the invention, the energy absorbing device comprises at least one, preferably several, strengthening profilings, for example, those which extend essentially in the longitudinal direction of the energy absorbing device. The strengthening elements can be provided on certain segments or along the entire length of the energy absorbing device. On the one hand, they hinder eversion but, on the other hand, they also hinder buckling under an axial load of the area at which they are provided.

The strengthening elements strengthen due to their cross section profile and, if they are shaped by forming, the strengthening resulting from this forming. The strengthening elements can be provided in addition or alternatively to any other strengthening elements of the area at which they are formed.

FIGS. 5 and 6 show the energy absorbing device according to the invention in an extension with strengthening profilings. In the walls of the second hollow longitudinal segment 3 and the overlapping transitional region 4 profilings 25, 26 are provided in such a manner that they extend in the longitudinal direction of the walls. The profilings modify the otherwise circular cross-sectional profile of second hollow longitudinal segment 3 and of the transitional region 4.

In this embodiment, the profilings are formed in an approximately corrugated manner with an approximately U-shaped cross-sectional profile. However, other cross-sectional profiles are possible, for example, V-shaped cross-sectional profiles.

In the present embodiment, the profilings impart to the outer peripheral surface 27 of the second hollow longitudinal segment 3 an approximately corrugated appearance with segments 50 projecting outwards in the radial direction. The profile of the inner peripheral surface 28 of the second hollow longitudinal segment 3 follows the profile of the outer peripheral surface 27 with groove-like indentations 51 formed in the area of the segments 50 projecting outwards in the radial direction.

The profilings extend over the entire area of the second longitudinal segment 3, where the second longitudinal segment 3 has an essentially uniform cross-sectional profile. This part of the profilings is indicated with the reference number 25. The profilings continue further into the transitional region 4, where they come to an end approximately in the area of the S-curve's part 13 adjacent to the second hollow longitudinal segment. In so doing, the profile height of this part 26 of the profilings along the wall decreases in the direction towards the first hollow longitudinal segment 2 and the profile width increases. That is, these parts 26 of the profilings each have spreading runouts 29.

By providing the profilings on the transitional area and/or on the second longitudinal segment, deformation at the expense of the first longitudinal segment is promoted and deformation of the second longitudinal segment and the transitional area is opposed.

Due to the lesser strength of the first longitudinal segment 2 an everting, energy absorbing deformation of the energy absorbing device 1 is at the expense of the first longitudinal segment 2, while the second longitudinal segment 3 remains essentially plastically undeformed, as is shown in FIG. 7. On eversion of the outer, first longitudinal segment 2 relatively more material must be deformed than if the inner, second longitudinal segment 3 were to be deformed by eversion. Consequently, more energy can be dissipated at the expense of the first longitudinal segment 2 using an eversion.

In one variant of the invention the everting deformation is essentially at the expense of the inner longitudinal segment, where the outer longitudinal segment remains essentially undeformed. That is, the inner longitudinal segment takes over the role of the “first longitudinal segment” and the outer longitudinal segment takes over the role of the “second longitudinal segment.” Also in the case of this variant of the invention, the deformation behavior, and thus the energy absorbing capacity, can be well determined in advance.

The energy absorbing device according to the invention comprises a bend protection, with which transverse forces can also be well absorbed by the energy absorbing device. This permits, even in the case of forces acting in the direction transverse to the longitudinal axis 52 of the energy absorbing device, everting deformation which absorbs energy well. Preferably forces can be taken up well which are at an angle of up to approximately 30° to the longitudinal axis 52, in particular an angle of approximately 10°, as this may happen during accidents with an incline of approximately 10° to the front of the obstacle.

In the case of this embodiment of the invention, the first and second longitudinal segments 2, 3 are to be somewhat telescoped together in the undeformed state of the energy absorbing device 1. That is, the second hollow longitudinal segment 3 is inserted to some extent into the first hollow longitudinal segment 2, as is shown, by way of example, in FIGS. 4 to 6. The further the second hollow longitudinal segment 3 is inserted into the first hollow longitudinal segment 2 the greater is the stability against buckling under a load in the axial direction. A load in the transverse direction of the first and second hollow longitudinal segments 2, 3 relative to one another is absorbed by the overlapping transition region 4. In so doing, the capacity for telescoping of the energy absorbing device is retained. A configuration of the transitional region 4, specifically that configuration required for everting deformation of the transitional region, is basically retained.

The energy absorbing device can be provided with a glide coating. Preferably, the glide coating is formed on the entire energy absorbing device but at least on the first hollow longitudinal segment 2. The glide coating improves a potential gliding of the walls of the energy absorbing device along one another during the telescoping. This supports good progression of the everting deformation.

Used particularly as a glide coating is a rust-protective coating which has glide-promoting properties. The glide coating can, for example, be a cathode lacquer.

In the case of the deformed energy absorbing device 1′ shown in FIG. 7, the second longitudinal segment 3 telescopes over a certain area into the first longitudinal segment, where the first hollow longitudinal segment has been deformed, beginning at the transitional region, in an everting manner with a reduction in diameter. The S-curve's outer part adjacent to the first longitudinal segment has bent and, taking its place, the active everted region 16 has, during the eversion, increased its distance relative to the S-curve's inner part 13 adjacent to the second longitudinal segment 3. The ends 17, 18 of the energy absorbing device have approached one another.

The transitional region 4′ is now formed by the everted region 16 which has migrated during the deformation and the S-curve's substantially undeformed inner part 13. The new transitional region 4′ consists of material 2″ deriving from the first hollow longitudinal segment and the bent part 12′ of the original S-curve.

The bent S-curve-portion 12′ forms a flat U in the longitudinal cross section of the deformed energy absorbing device 1′ since its material, due to its greater strength with respect to the first longitudinal segment, has not bent completely. Of the original first longitudinal segment 2, a remnant 2′ remains.

FIG. 8 shows a force-displacement diagram for the energy absorbing deformation of a system with a bumper and a body part of a vehicle with an energy absorbing device 1 disposed between the bumper and the body part. On the x-axis the approach of the ends is plotted as the displacement and on the y-axis the force applied to these ends of the system. A first displacement segment 19 comprises Hooke's range. With the transition into a second displacement segment 20 the plastic deformation of the energy absorbing device begins. Over the course of the second displacement segment 20 the expenditure of force increases in a certain segment and decreases once again thereafter. This increased expenditure of force is required for the bending of the S-curve's original outer part 12.

After the lowering of the expenditure of force in the second displacement segment 20, the expenditure of force increases clearly in a third displacement segment 21 by an amount indicated with the reference number 22. This clear increase of the expenditure of force is required for the deformation of the outer, first hollow longitudinal segment 2 by eversion with a reduction in diameter.

In the following the process according to the invention for producing the integral energy absorbing device 1 is described.

In FIG. 9 a tube 30 serving as starting material and having a first cross-sectional width 5 is shown. The tube 30 is narrowed in a certain segment to the second cross-sectional width 6, whereby the first and second hollow longitudinal segments 2, 3 are formed. By compressing the tube 30, the overlapping transitional region 4 between the longitudinal segments 2, 3 is formed.

Due to the narrowing, the area affected by this is strengthened by forming. A segment of the tube 30, specifically that segment not affected by the narrowing, namely the first hollow longitudinal segment 2 to be formed, retains its strength.

In FIG. 10 a first embodiment of the production process according to the invention is illustrated. To narrow the cross-sectional width in a certain segment, the tube 30 is drawn, in the direction of the arrow 31, through a die 32, which comprises a stepped forming segment 33, which preferably tapers approximately in the form of a cone. Thereby, a corresponding stepped transitional segment 34, which preferably tapers approximately in the form of a cone, develops in the tube 30.

In the state shown in FIG. 10, the forming of the tube 30 by the die 32 is practically finished and the first and second longitudinal segments 2, 3 have been formed. After removing the die 32, the tube is compressed, that is, the longitudinal segments 2 and 3 are pressed together. Thereby the transitional region 34 which tapers approximately in the form of a cone is reversely-drawn and the overlapping transitional region 4 having the form of an S develops, as shown in FIG. 4.

In this way a material segment of the tube 30, specifically the segment between the longitudinal segments 2, 3, is strengthened particularly well by being formed two times. The first time by the forming with the aid of the die 32 and the second time by the compression carried out subsequently. By forming two times an increase in strength of approximately 30% to 40% is possible.

In the case of an extension of the invention the walls of the energy absorbing device are profiled or embossed in a strengthening manner. This can be done by moving the energy absorbing device through a die which has a forming pattern which forms profilings.

In the case of a variant of the first embodiment of the production process according to the invention the profiling is done during the narrowing. For this, the forming segment 33 of the die 32 is provided with a forming pattern which forms the profilings 25 and 26. That is, the narrowing and the profiling are done simultaneously and are one integrated process.

After applying the die 32, profilings are comprised by the second hollow longitudinal segment 3 and an area of the transitional segment 34 of the tube 30, specifically that area of the transitional segment which is adjacent to the second hollow longitudinal segment and preferably tapers approximately in the form of a cone. Subsequently the compression takes place in the manner already described.

In FIG. 11 a second embodiment of the production process according to the invention is illustrated. In this embodiment the narrowing is done by rolling, where in FIG. 11 a roller tool 35 is only indicated in dotted lines. It moves, relative to the tube 30, in the direction of the arrow 36 and first of all forms a stepped transitional segment 37, which preferably tapers approximately in the form of a cone. After reaching the second cross-sectional width 6, the second hollow longitudinal segment 3 is formed.

Also in the case of this process, following the narrowing there is a compression to form the overlapping transitional segment 4 shown in FIG. 4, as has already been described with regard to the first embodiment of the production process according to the invention. The strengthening of the transitional region 4 achieved by forming two times is good.

In FIGS. 12 and 13 a third embodiment of the production process according to the invention is illustrated. Also in this embodiment the narrowing is done by rolling with the aid of the rolling tool indicated in dotted lines, where the rolling tool moves, relative to the tube 30, in the directions of the arrows 38. Unlike the second embodiment, however, compression takes place during the narrowing. That is, the compression is a process integrated into the narrowing.

In the case of the second embodiment, a volume of material which has become “excess” due to the narrowing has led to the increase of the total length of the tube 30, where the tube 30 has extended on sides of the second hollow longitudinal segment which is forming and has the smaller second cross-sectional width 6. In the case of the third embodiment of the production process according to the invention the material elongation associated with the narrowing is guided, at least in part, towards the first hollow longitudinal segment 2 which is forming or has already formed, whereby there is integrated compression. The guiding can be accomplished by the ends 40 and 41 of the tube 30 being held, at least essentially, in their distance from one another. In FIGS. 10 and 11 this holding is symbolized by the axial resisting elements 42, 43.

In FIG. 12 a transitional region is shown between the first hollow longitudinal segment 2 which has already formed and the second hollow longitudinal segment 3 which is forming, where that transitional region has been formed with the rolling tool 35. This transitional region 39 has a contour which is essentially still stepped, or tapers in the form of a cone, but already comprises slight roundings in the transition between the segments with the first and second cross-sectional diameters 5, 6. In FIG. 13 this transitional segment 39′ is still further reversely-drawn by the integrated compression, that is, with its rounded transitions it forms an S-shape to a still more pronounced degree. The integrated compression is continued until approximately the transitional region 4 shown in FIG. 4 is formed.

In the case of an extension of the production process according to the invention the wall thickness of the affected area is increased by narrowing the diameter. In so doing, a volume of material which has become “excess” due to the narrowing is used, at least in part, to increase the wall thickness, in particular to increase the wall thickness of the second hollow longitudinal segment.

In the case of variants of the production process according to the invention, reductions in the wall thickness of the tube 30 can occur during narrowing of the diameter, in particular in the area of the overlapping transitional region 4.

In FIG. 14 the energy absorbing device 1 according to the invention is shown with a stabilized transitional region 4. FIG. 14 shows in addition, by way of example, how the energy absorbing device can be disposed between a bumper 44 and a body 45 of a vehicle.

In the case of the energy absorbing device 12 shown in FIG. 14, walls 46, 47 of a fold 23 of the transitional region 4, specifically walls 46, 47 associated with the S-curve's inner part 13, are connected to one another by joining. The joining can be done by gluing, welding, or soldering. The joining material 49 represented in FIG. 14 in the inner radius 15 of the S-curve's inner part 13 is a two-component glue. By this joining the overlapping transitional region 4 is well stabilized and supports the deformation of the energy absorbing device 1 at the expense of the first hollow longitudinal segment 2 disposed on the outside.

In one variant of the invention, walls 47, 48 of another fold 24 of the transitional region 4 can be connected to one another by joining, namely walls 47, 48 associated with the S-curve's outer part 12. In this way a deformation of the energy absorbing device at the expense of the second hollow longitudinal segment 3 disposed on the inside is supported.

Stabilization by joining has an effect similar to a good strain hardening or providing a profiling of the overlapping transitional region 4. Stabilization by joining can be provided during the production process without, or with too little, strain hardening of the overlapping transitional region 4.

1. Energy absorbing device (1) comprising a first hollow longitudinal section (2) of a first cross-sectional width (5) and a second hollow longitudinal section (3) of a second cross-sectional width (6), and an overlapping transitional region (4) between the hollow longitudinal sections (2, 3), in which the second hollow longitudinal section (3) is formed as a narrowed tube section, and the transitional region (4) is formed as a compressed tube (30), wherein the transitional region is a section compressed during narrowing.

2. Energy absorbing device according to claim 1, wherein the second hollow longitudinal section (3) has a higher strength than the first hollow longitudinal section (2) and acquired this by deformation.

3. Energy absorbing device according to claim 1, wherein the second hollow longitudinal section (3) has a greater wall thickness (11) than the first hollow longitudinal section (2).

4. Energy absorbing device according to claim 1, wherein the transitional region (4) has a higher strength than the first hollow longitudinal section (2).

5. Energy absorbing device according to claim 1, wherein the energy absorbing device (1) has a strengthening profiling (25, 26) in its wall.

6. Energy absorbing device according to claim 5, wherein the profiling (25, 26) is formed extending substantially in the longitudinal direction of the energy absorbing device (1).

7. Energy absorption device according to claim 5, wherein the profiling (25) is provided to extend approximately over the entire area of the second hollow longitudinal section (3).

8. Energy absorbing device according to claim 5, wherein the profiling (26) is provided in the overlapping transitional region (4) adjacent to the second hollow longitudinal section (3).

9. Energy absorbing device according to claim 1, wherein the transitional region (4) has at least an inner radius (14, 15) in the range from about 1 mm to about 4 mm.

10. Energy absorbing device according to claim 1, wherein the transitional region (4) comprises a fold (23) formed on the sides of the second longitudinal hollow section (3), whose walls (46, 47) are connected to each other by joining (49).

11. Energy absorbing device according to claim 10, wherein the walls (46, 47) are welded, soldered or glued to each other.

12. Energy absorbing device according to claim 1, wherein the energy absorbing device has wall thicknesses (10, 11) in the range from about 1 mm to about 4 mm.

13. Energy absorbing device according to claim 1, wherein the energy absorbing device (1) is integrally formed.

14. Method for production of an integral energy absorbing device (1) comprising a first hollow longitudinal section (2) of first cross-sectional width (5) and a second hollow longitudinal section (3) of second cross-sectional width (6), and an overlapping transitional region (4) between the hollow longitudinal sections (2, 3), the method comprising the followings steps:
narrowing in sections of a tube (30) of first cross-sectional width (5) to the second cross-sectional width (6) to form hollow longitudinal sections (2, 3) of the first and second cross-sectional width (5, 6), and
compressing tube (30), so that the overlapping transitional region (4) is formed,
wherein the compressing is carried out during narrowing.

15. Method according to claim 14, wherein a material elongation accompanying the narrowing is guided at least in part in the direction toward the first hollow longitudinal section (2), whereby the transitional region (39, 39′) is reversely-drawn between longitudinal sections (2, 3).

16. Method according claim 14, wherein both end regions (40, 41) of tube (30) are held in the longitudinal direction of the tube during the narrowing, and wherein a material elongation accompanying the narrowing and a reverse-drawing of the transitional region (39, 39′) occur between the hollow longitudinal sections (2, 3).

17. Method according to claim 14, wherein the compressing is carried out after narrowing.

18. Method according to claim 14, wherein the wall thickness (11) of the second hollow longitudinal section (3) is increased during narrowing.

19. Method according to claim 14, wherein narrowing occurs by rolling.

20. Method according to claim 14, wherein narrowing occurs by movement of the tube (30) through a die (32) that narrows the cross-sectional width.

21. Method according to claim 19, wherein a stepped transitional region (34, 37) is formed with narrowing between the longitudinal sections (2, 3).

22. Method according to claim 14, wherein the wall of the energy absorbing device (1) is profiled in a strengthening manner during narrowing.

23. Method according to claim 20, wherein narrowing and profiling are performed with the same die (32).

24. Energy absorbing device according to claim 2, wherein the second hollow longitudinal section (3) has a greater wall thickness (11) than the first hollow longitudinal section (2).

25. Energy absorbing device according to claim 9, wherein the transitional region (4) has at least an inner radius (14, 15) in the range of about 1.5 mm.

26. Energy absorbing device according to claim 12, wherein the energy absorbing device has wall thicknesses (10, 11) in the range from about 1.5 mm to about 2.5 mm.

27. Method according to claim 21, wherein a conical transitional region (34, 37) is formed with narrowing between the longitudinal sections (2,3).
